(19) United States
(12) Patent Application Publication
(10) Pub. No.: US 2026/0189459 A1
(43) Pub. Date: Jul. 2, 2026

(54) WIRELESS CLUSTERING FOR RACK-MOUNTED INFORMATION HANDLING SYSTEMS

(71) Applicant: Dell Products L.P., Round Rock, TX (US)

(72) Inventors: Parminder Singh Sethi, Ludhiana (IN); Pandiyarajan Mani, Gudiyattam (IN); Paresh Pattanaik, Bangalore (IN)

(73) Assignee: Dell Products L.P., Round Rock, TX (US)

(21) Appl. No.: 19/004,798

(22) Filed: Dec. 30, 2024

(51) Int. Cl. H04L 41/0893; H04L 41/0813

(52) U.S. Cl. CPC H04L 41/0893; H04L 41/0813

(57) ABSTRACT

Systems and methods are provided for wireless configuration of a managed cluster that includes a plurality of IHSs (Information Handling Systems). A lead IHS is selected for the managed cluster. The lead IHS is directed to utilize a specified wireless network in administration of IHSs that are members of the managed cluster. A list is generated of IHSs to be included as members of the managed cluster. The lead IHS initiates a wireless connection with each of the plurality of IHSs in the list of IHSs to be included as members of the managed cluster. The lead IHS uses the wireless connection with each of the plurality of IHSs to configure each respective IHS as a member of the managed cluster.

### FIELD

The present disclosure relates generally to Information Handling Systems (IHSs), and relates more particularly to the configuration of managed clusters from groups of IHSs.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Groups of IHSs may be housed within data center environments. A data center may include a large number of IHSs, such as enterprise-class servers that are stacked and installed within racks. Each server IHS within a data center may support a wide variety of possible hardware and software configurations. In some instances, rack-mounted servers of a datacenter may be grouped into managed clusters, in which the member servers may be jointly managed in light of the hardware and software commonalities between the servers. Such managed clusters are distinct from computing clusters through which the servers are tasked, in many instances through virtualization of the underlying hardware that is being managed through the operation of the managed cluster.

### SUMMARY

In various embodiments, systems and methods are provided for wireless configuration of a managed cluster comprising a plurality of IHSs (Information Handling Systems). Embodiments may include: selecting a lead IHS for the managed cluster; directing the lead IHS to utilize a specified wireless network in administration of IHSs that are members of the managed cluster; generating a list of IHSs to be included as members of the managed cluster; initiating, by the lead IHS, a wireless connection with each of the plurality of IHSs in the list of IHSs to be included as members of the managed cluster; and using, by the lead IHS, the wireless connection with each of the plurality of IHSs to configure each respective IHS as a member of the managed cluster.

Some embodiments may include directing the lead IHS to generate the list of IHSs to be included in the managed cluster based on wireless broadcast notifications. In some embodiments, the lead IHS is provided a subnet address for use in transmitting the wireless broadcast notifications. In some embodiments, each of the plurality of IHSs to be included as members of the managed cluster is configured to monitor for broadcasts on the subnet address in order to initiate wireless administration by the lead IHS as a member of the managed cluster. In some embodiments, each of the plurality of IHSs to be included as members of the managed cluster is further configured to monitor for broadcast notifications by a wireless management network identified by a specific SSID. In some embodiments, the lead IHS broadcasts the wireless clustering notifications on one or more wireless networks of a datacenter. In some embodiments, the list of IHSs to be included as members of the managed cluster comprises IHSs that respond to the wireless clustering notification broadcast by the lead IHS. In some embodiments, the generated list of IHSs to be included as members of the managed cluster comprises credentials for use in authenticating each of the respective IHSs in the list. In some embodiments, the lead IHS utilizes the credentials to establish a secure wireless connection with each IHS in the list. Some embodiments may further include identifying, by the lead IHS, a subset of the IHSs to be included as members of the managed cluster that each include a specific hardware system not present in other IHSs to be included as members of the managed cluster and generate a managed sub-cluster that includes the subset of the IHSs that include the specific hardware system. In some embodiments, the managed sub-cluster is utilized by the lead IHS administration of the specific hardware system utilized by the subset of IHSs. Some embodiments, reassigning a first IHS from membership in the managed cluster administered by the lead IHS to membership in a different managed cluster that is administered by a different lead IHS. In some embodiments, the reassignment of the first IHS comprises directing the first IHS to switch to use of a wireless network in use by the different IHS in management of the different managed cluster.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIG. 1 is a diagram illustrating certain components of a chassis, according to some embodiments, that includes multiple IHSs that may be wirelessly configured as members of a managed cluster.

FIG. 2 is a diagram illustrating certain components of an IHS configured, according to some embodiments, for wireless membership in a managed cluster.

FIG. 3 is a diagram illustrating a prior art wired configuration of a managed cluster.

FIG. 4 is a flowchart illustrating certain steps of methods, according to some embodiments, for wireless configuration of rack-mounted IHSs as members of a managed cluster.

### DETAILED DESCRIPTION

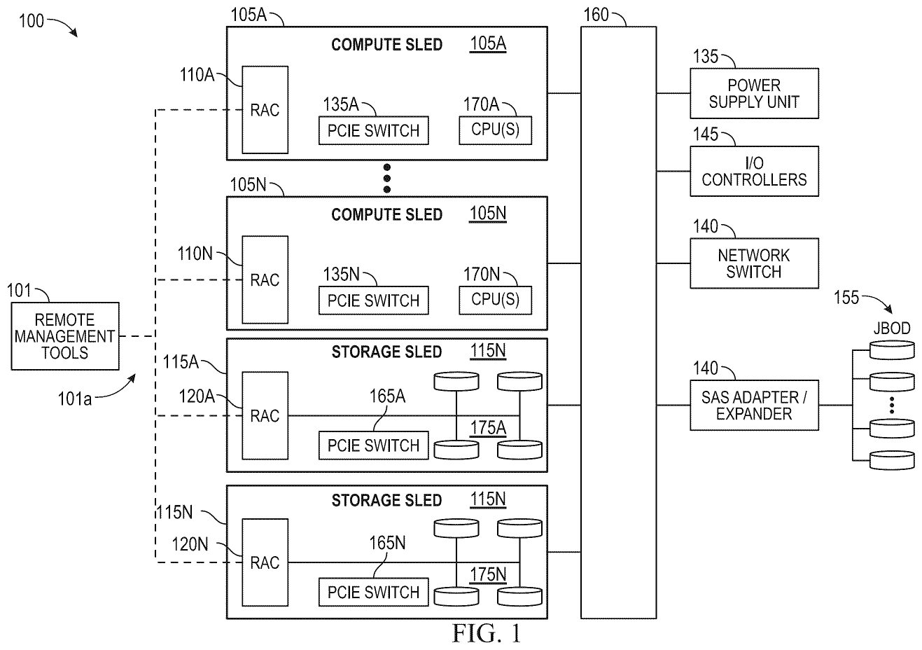

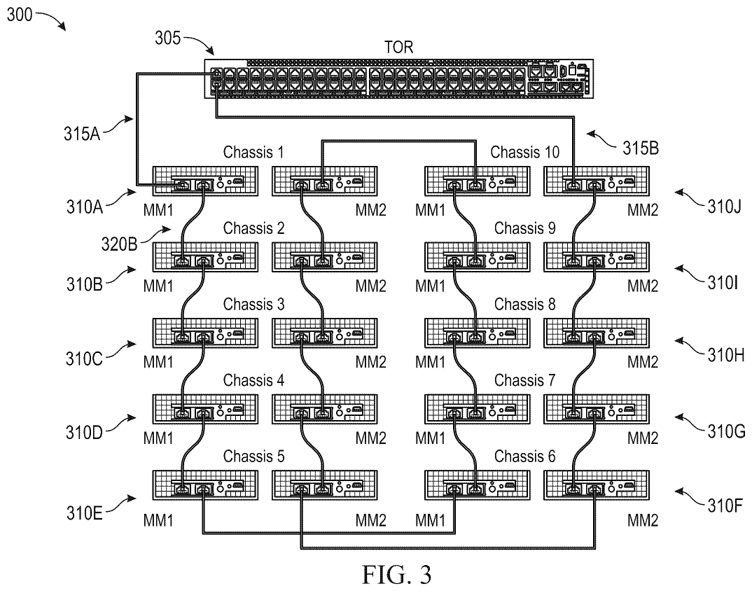

FIG. 1 is a block diagram illustrating certain components of a chassis 100 comprising one or more compute sleds 105a-n and one or more storage sleds 115a-n that may be collectively and/or individually configured to implement the systems and methods described herein for wireless configuration as members of a managed cluster. In existing managed clusters, the membership of servers, such as sleds 105a-n, 115a-n, in a cluster is established through wired connections between the members of the cluster. As described in additional detail with regard to FIG. 3, existing managed clusters are created by forming a physical stack of servers that are connected to each other through wired connections. In embodiments, a similar configurations of members servers may be generated and jointly managed, but instead using wireless connectivity between the members servers of the managed cluster and a lead server in charge of the managed cluster. In some embodiments, each of the servers installed in chassis 100 that are configured for wireless clustering may be adapted to identify neighboring servers that are within wireless range and that are similarly configured for wireless clustering.

Embodiments of chassis 100, from which a managed cluster may be configured, include a wide variety of different hardware configurations. Such variations in hardware configuration may result from chassis 100 being factory configured to include components specified by a customer that has contracted for manufacture, provisioning and delivery of the chassis. Configured in this manner, a chassis 100 may be combined with neighboring chassis to build a managed cluster that may be managed as a single entity and that combines the capabilities of the participating sleds 105a-n, sleds 115a-n and/or other hardware that may be included in the managed cluster, such as network switches 140 and power supplies 135.

All of the hardware components of the chassis 100 may be installed within a rack that may include one or more slots that each receive an individual sled (that may be additionally or alternatively referred to as a server, node and/or blade), such as compute sleds 105a-n and storage sleds 115a-n. A rack may support a variety of different numbers, sizes (e.g., 1RU, 2RU) and physical configurations of slots. Chassis 100 may support additional types of sleds that may be installed within a rack and provide various types of storage and/or processing capabilities. Sleds may be individually installed and removed from a rack, thus allowing the computing and storage capabilities of a rack, and thus of a chassis 100, to be reconfigured, in many cases without affecting the operation of the other hardware installed in the rack.

The modular architecture provided by the rack allows for certain resources, such as cooling, power and network bandwidth, to be shared by the compute sleds 105a-n and storage sleds 115a-n or other hardware installed in the rack, thus providing efficiency improvements and supporting greater computational loads. Rack may provide all or part of the cooling utilized by sleds 105a-n, 115a-n of a chassis 100. For airflow cooling, a rack may include one or more banks of cooling fans that may be operated to ventilate heated air away from the hardware that is installed within the rack. In some embodiments, rack may include liquid cooling manifolds that can be connected to IHSs or other hardware in providing these components with liquid cooling capabilities.

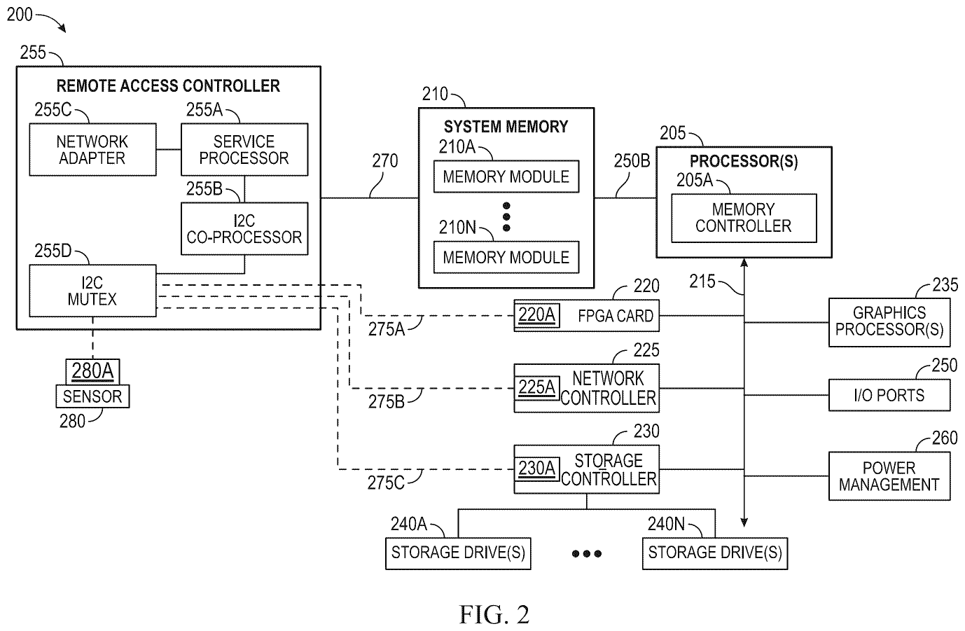

In certain embodiments, a compute sled 105a-n may be an IHS such as described with regard to IHS 200 of FIG. 2. A compute sled 105a-n may provide computational processing resources that may be used to support a variety of e-commerce, multimedia, business and scientific computing applications, such as services provided via a cloud implementation. Compute sleds 105a-n are typically configured with hardware and software that provide leading-edge computational capabilities. Accordingly, services provided using such computing capabilities are typically provided as high-availability systems that operate with minimum downtime. As described in additional detail with regard to FIG. 2, compute sleds 105a-n may be configured for general-purpose computing or may be optimized for specific computing tasks.

As illustrated, each compute sled 105a-n includes a remote access controller (RAC) 110a-n. As described in additional detail with regard to FIG. 2, remote access controller 110a-n provides capabilities for remote monitoring and management of compute sled 105a-n. In support of these monitoring and management functions, remote access controllers 110a-n may utilize both in-band 160 and sideband (i.e., out-of-band) 101a communications by compute sled 105a-n. Remote access controllers 110a-n may collect various types of sensor data, such as collecting temperature sensor readings that are used in support of airflow cooling of the sleds 105a-n, 115a-n. In addition, each remote access controller 110a-n may implement various monitoring and administrative functions related to compute sleds 105a-n that utilize sideband bus connections with various internal components of the respective compute sleds 105a-n.

As described in additional detail below, in some embodiments, the networking and administrative capabilities provided by remote access controllers 110a-n, 120a-n may be utilized in wireless configuration of sleds 105a-n, 115a-n as members of managed clusters. Remote access controllers 110a-n, 120a-n may utilize onboard wireless networking capabilities, that may be regarded as sideband connections, to communicate with nearby remote access controllers in identifying neighboring servers that are configured for wireless clustering. In some embodiments, remote access controllers 110a-n, 120a-n may be further utilized in completing handshake procedures to authenticate neighboring servers for configuration as members of a managed cluster. As described in additional detail below, a remote access controllers 110a-n, 120a-n of an IHS that has been designated as leader of the managed cluster may be further configured to broadcast wireless configuration signals and to identify neighboring IHSs that respond to the broadcast signal and that can be authenticated and subsequently added as members of the managed cluster.

Implementing computing clusters that span multiple processing components (e.g., 105a-n, 115a-n) may be aided by high-speed data links between these processing components, such as PCIe connections that form one or more distinct PCIe switch fabrics 160 that may implemented by network switches 140 and PCIe switches 135a-n, 165a-n installed in the IHSs 105a-n, 115a-n. These high-speed data links may be used to support software that operates spanning multiple processing, networking and storage components of a computing cluster. Once configured using such high-speed data links, a computing cluster may be tasked and operated as a single component, without regard to the individual hardware components that are members of the computing cluster.

As illustrated, chassis 100 may also include one or more storage sleds 115a-n that may be installed within one or more slots of a rack, in a similar manner to compute sleds 105a-n. Also in the same manner as compute sleds 105a-n, each of the storage sleds 115a-n may be configured for membership in a managed cluster, where the storage sled is identified and configured for cluster membership through wireless communications with a lead server. Each of the individual storage sleds 115a-n may include various different numbers and types of storage devices. For instance, storage sleds 115a-n may include SAS (Serial Attached SCSI) magnetic disk drives, SATA (Serial Advanced Technology Attachment) magnetic disk drives, solid-state drives (SSDs) and other types of storage drives in various combinations. As illustrated, each storage sled 115a-n includes a remote access controller (RAC) 120a-n provides capabilities for remote monitoring and management of respective storage sleds 115a-n. In some embodiments, each of the storage sleds 115a-n may include a PCIe switch 165a-n for use in coupling the sleds to a switch fabric 160, by which the storage sleds may interface with other members of the computing cluster.

The remote access controllers 110a-n, 120a-n that are present in a managed cluster may support secure connections with remote management tools 101. In some embodiments, remote management tools 101 provides a remote administrator, whether manual or automated, with various capabilities for remotely administering the operation of an individual IHS, and/or of a managed cluster formed from multiple IHSs. The remote management tools 101 may also include various monitoring interfaces for evaluating telemetry data collected by the remote access controllers 110a-n, 120a-n. In some embodiments, remote management tools 101 may communicate with remote access controllers 110a-n, 120a-n via a protocol such the Redfish remote management interface.

As described in additional detail below, through the operation of remote management tools 101, a human and/or automated administrator may issue commands directing the creation of a managed cluster. As described above, existing systems rely on wired connections for identifying and ordering the members of a managed cluster in a physically stacked configuration. Some managed cluster applications may rely on this stacked topology of IHS servers withing a cluster, whereby each member of the cluster is physically connected to a limited number of nearby members. Through embodiments, wireless configuration of clusters is supported, where some embodiments may utilize wireless networking in a manner that organizes the members in a wireless topology that parallels the stacked topologies used in existing wired networking systems, and used in some remote management tools 101.

Though the use of remote management tools 101, embodiments support various procedures for wireless clustering of IHSs. As described in additional detail below, embodiments support wireless clustering of specifically identified IHSs that are to be members of a managed cluster, such as based on a listing of network addresses and credentials to be used in wirelessly interfacing and authenticating each of the participating IHSs. Embodiments may also support wireless clustering of all IHSs that can provide an authenticated response to a broadcast notification issued by an IHS that has been designated as leader of the cluster. In such configurations, the listing of IHSs that are to be members of the cluster do not have to be specifically enumerated and are instead ascertained by the IHS that has been designated as the leader.

As illustrated, the chassis 100 of FIG. 1 includes a network switch 140 that may provide network access to the sleds 105a-n, 115a-n of the cluster. Network switch 140 may include various switches, adapters, controllers and couplings used to connect hardware systems installed in chassis 100 to a network and/or to each other. Whereas the illustrated embodiment of FIG. 1 includes a single network switch in a chassis 100, different embodiments may operate using different numbers of network switches.

In some embodiments, network switch 140 may be a PCIe switch 265a-b that implements switch fabric 160 and operates as an I/O controller for PCIe communications, such as TLPs (Transaction Layer Packets), that are transmitted between the hardware components (e.g., compute sleds 105a-n and storage sleds 115a-n) that are members of the same computing cluster. In addition to serving as I/O controllers that route PCIe traffic, a PCIe network switch 140 includes switching logic that can be used to expand the number of PCIe connections that are supported in the switch fabric 160. For instance, a PCIe network switch 140 may multiply the number of PCIe lanes available via the switch fabric 160.

In some embodiments, chassis 100 may include one or more power supply units 135 that provides the components of the chassis with various levels of DC power from an AC power source or from power delivered via a power system that may be provided by a rack within which the chassis 100 is installed. In certain embodiments, power supply unit 135 may be implemented within a sled that may provide the chassis 100 with multiple redundant, hot-swappable power supply units.

In addition to the data storage capabilities provided by storage sleds 115a-n, chassis 100 include other storage resources that may be installed within a rack housing the chassis, such as within a storage blade. In certain scenarios, such storage resources 155 may be accessed via a SAS expander 150 that is coupled to the switch fabric 160 of the chassis. The SAS expander 150 may support connections to a number of JBOD (Just a Bunch Of Disks) storage drives 155 that may be configured and managed individually and without implementing data redundancy across the various drives 155.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

FIG. 2 shows an example of an IHS 200 configured to implement systems and methods described herein for supporting for wireless membership of the IHS 200 in a managed cluster. It should be appreciated that although the embodiments described herein may describe an IHS that is a compute sled or similar computing component that may be deployed within slots of a rack, other embodiments may be utilized with other types of IHSs that may also be members of a managed cluster according to embodiments. In the illustrative embodiment of FIG. 2, IHS 200 may be a computing component, such as compute sled 105a-n or other type of server, such as an 1RU server installed within a 2RU chassis, that is configured to share infrastructure resources provided by a rack.

As described, an IHS 200 may be assembled and provisioned according to customized specifications provided by a customer. The IHS 200 of FIG. 2 may be a compute sled, such as compute sleds 105a-n of FIG. 1, that may be installed within a rack in a data center. Installed in this manner, IHS 200 may utilize shared power, network and cooling resources provided by the rack. Embodiments of IHS 200 may include a wide variety of different hardware configurations. Such variations in hardware configuration may result from IHS 200 being factory assembled to include components specified by a customer that has contracted for manufacture and delivery of IHS 200. IHS 200 may include capabilities that allow a customer to validate that the hardware components of IHS 200 are the same hardware components that were installed at the factory during its manufacture, where these validations of the IHS hardware may be initially completed using a factory-provisioned inventory certificate. As described in additional detail below, IHS 200 may include capabilities that allow a customer to validate the hardware during initialization of the IHS 200 as being the same factory installed and provisioned hardware that was supplied to the customer.

IHS 200 may utilize one or more processors 205. In some embodiments, processors 205 may include a main processor and a co-processor, each of which may include a plurality of processing cores that, in certain scenarios, may each be used to run an instance of a server process. In certain embodiments, one or all of processor(s) 205 may be graphics processing units (GPUs) in scenarios where IHS 200 has been configured to support functions such as multimedia services and graphics applications.

As illustrated, processor(s) 205 includes an integrated memory controller 205a that may be implemented directly within the circuitry of the processor 205, or the memory controller 205a may be a separate integrated circuit that is located on the same die as the processor 205. The memory controller 205a may be configured to manage the transfer of data to and from the system memory 210 of the IHS 205 via a high-speed memory interface 205b. The system memory 210 is coupled to processor(s) 205 via a memory bus 205b that provides the processor(s) 205 with high-speed memory used in the execution of computer program instructions by the processor(s) 205. Accordingly, system memory 210 may include memory components, such as static RAM (SRAM), dynamic RAM (DRAM), NAND Flash memory, suitable for supporting high-speed memory operations by the processor(s) 205. In certain embodiments, system memory 210 may combine both persistent, non-volatile memory and volatile memory.

In certain embodiments, the system memory 210 may be comprised of multiple removable memory modules. The system memory 210 of the illustrated embodiment includes removable memory modules 210a-n. Each of the removable memory modules 210a-n may correspond to a printed circuit board memory socket that receives a removable memory module 210a-n, such as a DIMM (Dual In-line Memory Module), that can be coupled to the socket and then decoupled from the socket as needed, such as to upgrade memory capabilities or to replace faulty memory modules. Other embodiments of IHS system memory 210 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 200 may utilize a chipset that may be implemented by integrated circuits that are connected to each processor 205. All or portions of the chipset may be implemented directly within the integrated circuitry of an individual processor 205. The chipset may provide the processor(s) 205 with access to a variety of resources accessible via one or more in-band buses 215. Various embodiments may utilize any number of buses to provide the illustrated pathways served by in-band bus 215. In certain embodiments, in-band bus 215 may include a PCIe (PCI Express) switch fabric that is accessed via a PCIe root complex. IHS 200 may also include one or more I/O ports 250, such as PCIe ports, that may be used to couple the IHS 200 directly to other IHSs, storage resources and/or other peripheral components.

As illustrated, IHS 200 may include one or more FPGA (Field-Programmable Gate Array) cards 220. Each of the FPGA card 220 supported by IHS 200 may include various processing and memory resources, in addition to an FPGA logic unit that may include circuits that can be reconfigured after deployment of IHS 200 through programming functions supported by the FPGA card 220. Through such reprogramming of such logic units, each individual FGPA card 220 may be optimized to perform specific processing tasks, such as specific signal processing, security, data mining, and artificial intelligence functions, and/or to support specific hardware coupled to IHS 200. In some embodiments, a single FPGA card 220 may include multiple FPGA logic units, each of which may be separately programmed to implement different computing operations, such as in computing different operations that are being offloaded from processor 205. The FPGA card 220 may also include a management controller 220a that may support interoperation with the remote access controller 255 via a sideband device management bus 275a.

Processor(s) 205 may also be coupled to one or more network controllers 225 via in-band bus 215, such as provided by a Network Interface Controller (NIC) that allows the IHS 200 to communicate via an external network, such as the Internet or a LAN. In some embodiments, network controllers 225 may include a replaceable expansion card or adapter that is coupled to a motherboard connector of IHS 200. As described, a PCIe switch may be used by the IHS 200 to interface with other members of a computing cluster installed in chassis 100 and accessible via a switch fabric 160.

IHS 200 may include one or more storage controllers 230 that may be utilized to access storage drives 240a-n that are accessible via a rack in which IHS 100 is installed. Storage controller 230 may provide support for RAID (Redundant Array of Independent Disks) configurations of logical and physical storage drives 240a-n. In some embodiments, storage controller 230 may be an HBA (Host Bus Adapter) that provide more limited capabilities in accessing physical storage drives 240a-n. In some embodiments, storage drives 240a-n may be replaceable, hot-swappable storage devices that are installed within bays provided by the chassis in which IHS 200 is installed. In embodiments where storage drives 240a-n are hot-swappable devices that are received by bays of chassis, the storage drives 240a-n may be coupled to IHS 200 via couplings between the bays of the chassis and a midplane of IHS 200. In some embodiments storage drives 240a-n may also be accessed by other IHSs that are also installed within the same chassis as IHS 100. Storage drives 240a-n may include SAS (Serial Attached SCSI) magnetic disk drives, SATA (Serial Advanced Technology Attachment) magnetic disk drives, solid-state drives (SSDs) and other types of storage drives in various combinations.

A variety of additional components may be coupled to processor(s) 205 via in-band bus 215. For instance, processor(s) 205 may also be coupled to a power management unit 260 that may interface with the power system unit 135 of the chassis 100 in which an IHS may be a member. In certain embodiments, a graphics processor 235 may be comprised within one or more video or graphics cards, or an embedded controller, installed as components of the IHS 200. In certain embodiments, graphics processor 235 may be an integrated component of the remote access controller 255 and may be utilized to support the display of diagnostic and administrative interfaces related to IHS 200 via display devices that are coupled, either directly or remotely, to remote access controller 255.

In certain embodiments, IHS 200 may operate using a BIOS (Basic Input/Output System) that may be stored in a non-volatile memory accessible by the processor(s) 205. The BIOS may provide an abstraction layer by which the operating system of the IHS 200 interfaces with the hardware components of the IHS. Upon powering or restarting IHS 200, processor(s) 205 may utilize BIOS instructions to initialize and test hardware components coupled to the IHS, including both components permanently installed as components of the motherboard of IHS 200 and removable components installed within various expansion slots supported by the IHS 200. The BIOS instructions may also load an operating system for use by the IHS 200. In certain embodiments, IHS 200 may utilize Unified Extensible Firmware Interface (UEFI) in addition to or instead of a BIOS. In certain embodiments, the functions provided by a BIOS may be implemented, in full or in part, by the remote access controller 255. As described in additional detail below, in some embodiments, BIOS may be configured to identify hardware components that are detected as being currently installed in IHS 200. In such instances, the BIOS may support queries that provide the described unique identifiers that have been associated with each of these detected hardware components by their respective manufacturers, thereby supporting attestation of the detected hardware as factory-installed.

In some embodiments, IHS 200 may include a TPM (Trusted Platform Module) that may include various registers, such as platform configuration registers, and a secure storage, such as an NVRAM (Non-Volatile Random-Access Memory). The TPM may also include a cryptographic processor that supports various cryptographic capabilities. In IHS embodiments that include a TPM, a pre-boot process implemented by the TPM may utilize its cryptographic capabilities to calculate hash values that are based on software and/or firmware instructions utilized by certain core components of IHS, such as the BIOS and boot loader of IHS 200. These calculated hash values may then be compared against reference hash values that were previously stored in a secure non-volatile memory of the IHS, such as during factory provisioning of IHS 200. In this manner, a TPM may establish a root of trust that includes core components of IHS 200 that are validated as operating using instructions that originate from a trusted source.

As described, IHS 200 may include a remote access controller 255 that supports remote management of IHS 200 and of various internal components of IHS 200. In certain embodiments, remote access controller 255 may operate from a different power plane from the processors 205 and other components of IHS 200, thus allowing the remote access controller 255 to operate, and management tasks to proceed, while the processing cores of IHS 200 are powered off. As described, various functions provided by the BIOS, including launching the operating system of the IHS 200, may be implemented by the remote access controller 255. In some embodiments, the remote access controller 255 may perform various functions to verify the integrity of the IHS 200 and its hardware components prior to initialization of the operating system of IHS 200 (i.e., in a bare-metal state).

As described with regard to FIG. 1, an IHS 200 according to some embodiments may utilize wireless communications supported by remote access controller 255 in configuring the IHS as a member of a managed cluster. In some embodiments, remote access controller 255 may utilize onboard wireless networking capabilities 255c, that may be regarded as sideband connections separate from in-band 215 networking of the IHS, to communicate with nearby remote access controllers in identifying neighboring IHSs that are configured for wireless clustering.

In some embodiments, remote access controller 255 may implement handshake procedures for authenticating neighboring IHSs for configuration as members of a managed cluster. As described in additional detail below, a remote access controller 255 of an IHS 200 that has been designated as leader of a managed cluster may be further configured to broadcast wireless configuration signals, and to identify neighboring IHSs that respond to the broadcast signal and that can be authenticated and subsequently added as members of the managed cluster. In some embodiments, the authentication of IHSs that respond to wireless clustering communications may be implemented by remote access controller 255 through use of the factory-provisioned inventor certificate of the responding servers for verification of the responding server as using only factory-installed hardware.

In some embodiments, remote access controller 255 may be uniquely identified based on a code or other identifier that may be permanently encoded in a non-volatile memory of the remote access controller 255 by its manufacturer. As described below, embodiments support validation of remote access controller 255 as being the same controller that was installed at the factory during the manufacture of IHS 200. Also as described below, during a provisioning phase of the factory assembly of IHS 200, a signed certificate that specifies factory installed hardware components of IHS 200 that were installed during manufacture of the IHS 200 may be stored in a non-volatile memory that is accessed by remote access controller 255. Using this signed inventory certificate stored by the remote access controller 255, a customer may validate that the detected hardware components of IHS 200 are the same hardware components that were installed at the factory during manufacture of IHS 200.

In support of the capabilities for validating the detected hardware components of IHS 200 against the inventory information that is specified in a signed inventory certificate, remote access controller 255 may include various cryptographic capabilities. For instance, remote access controller 255 may include capabilities for key generation such that remote access controller may generate keypairs that include a public key and a corresponding private key. As described in additional detail below, using generated keypairs, remote access controller 255 may digitally sign inventory information collected during the factory assembly of IHS 200 such that the integrity of this signed inventory information may be validated at a later time using the public key by a customer that has purchased IHS 200. Using these cryptographic capabilities of the remote access controller, the factory installed inventory information that is included in an inventory certificate may be anchored to a specific remote access controller 255, since the keypair used to sign the inventory information is signed using the private key that is generated and maintained by the remote access controller 255.

In some embodiments, the cryptographic capabilities of remote access controller 255 may also include safeguards for encrypting any private keys that are generated by the remote access controller and further anchoring them to components within the root of trust of IHS 200. For instance, a remote access controller 255 may include capabilities for accessing hardware root key (HRK) capabilities of IHS 200, such as for encrypting the private key of the keypair generated by the remote access controller. In some embodiments, the HRK may include a root key that is programmed into a fuse bank, or other immutable memory such as one-time programmable registers, during factory provisioning of IHS 200. The root key may be provided by a factory certificate authority, such as described below. By encrypting a private key using the hardware root key of IHS 200, the hardware inventory information that is signed using this private key is further anchored to the root of trust of IHS 200. If a root of trust cannot be established through validation of the remote access controller cryptographic functions that are used to access the hardware root key, the private key used to sign inventory information cannot be retrieved. In some embodiments, the private key that is encrypted by the remote access controller using the HRK may be stored to a replay protected memory block (RPMB) that is accessed using security protocols that require all commands accessing the RPMB to be digitally signed using a symmetric key and that include a nonce or other such value that prevents use of commands in replay attacks. Stored to an RPMG, the encrypted private key can only be retrieved by a component within the root of trust of IHS 200, such as the remote access controller 255.

Remote access controller 255 may include a service processor 255a, or specialized microcontroller, that operates management software that supports remote monitoring and administration of IHS 200. Remote access controller 255 may be installed on the motherboard of IHS 200 or may be coupled to IHS 200 via an expansion slot provided by the motherboard. In support of remote monitoring functions, network adapter 225c may support connections with remote access controller 255 using wired and/or wireless network connections via a variety of network technologies.

In some embodiments, remote access controller 255 may support monitoring and administration of various managed devices 220, 225, 230, 280 of an IHS via a sideband bus interface. For instance, messages utilized in device management may be transmitted using I2C sideband bus connections 275a-d that may be individually established with each of the respective managed devices 220, 225, 230, 280 through the operation of an I2C multiplexer 255d of the remote access controller. As illustrated, certain of the managed devices of IHS 200, such as non-standard hardware 220, network controller 225 and storage controller 230, are coupled to the IHS processor(s) 205 via an in-line bus 215, such as a PCIe root complex, that is separate from the I2C sideband bus connections 275a-d used for device management. The management functions of the remote access controller 255 may utilize information collected by various managed sensors 280 located within the IHS. For instance, temperature data collected by sensors 280 may be utilized by the remote access controller 255 in support of closed-loop airflow cooling of the IHS 200.

In certain embodiments, the service processor 255a of remote access controller 255 may rely on an I2C co-processor 255b to implement sideband I2C communications between the remote access controller 255 and managed components 220, 225, 230, 280 of the IHS. The I2C co-processor 255b may be a specialized co-processor or micro-controller that is configured to interface via a sideband I2C bus interface with the managed hardware components 220, 225, 230, 280 of IHS. In some embodiments, the I2C co-processor 255b may be an integrated component of the service processor 255a, such as a peripheral system-on-chip feature that may be provided by the service processor 255a. Each I2C bus 275a-d is illustrated as single line in FIG. 2. However, each I2C bus 275a-d may be comprised of a clock line and data line that couple the remote access controller 255 to I2C endpoints 220a, 225a, 230a, 280a which may be referred to as modular field replaceable units (FRUs).

As illustrated, the I2C co-processor 255b may interface with the individual managed devices 220, 225, 230, 280 via individual sideband I2C buses 275a-d selected through the operation of an I2C multiplexer 255d. Via switching operations by the I2C multiplexer 255d, a sideband bus connection 275a-d may be established by a direct coupling between the I2C co-processor 255b and an individual managed device 220, 225, 230, 280. In providing sideband management capabilities, the I2C co-processor 255b may each interoperate with corresponding endpoint I2C controllers 220a, 225a, 230a, 280a that implement the I2C communications of the respective managed devices 220, 225, 230. The endpoint I2C controllers 220a, 225a, 230a, 280a may be implemented as a dedicated microcontroller for communicating sideband I2C messages with the remote access controller 255, or endpoint I2C controllers 220a, 225a, 230a, 280a may be integrated SoC functions of a processor of the respective managed device endpoints 220, 225, 230, 280.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 205 as a systems-on-a-chip.

FIG. 3 is a diagram illustrating a prior art wired configuration of a wired managed cluster 300. In such existing managed cluster systems, all servers or other participating hardware systems 310a-j are stacked physically in close proximity to each other in order to support wired connections between the members of the cluster. In such existing system, it is through these wired connections that cluster members discover each other. Physically stacking and coupling servers in this manner in a scalable datacenter environment poses numerous challenges.

Wired cluster configurations require large numbers of cables, such as RJ45 ethernet cables. The number of cables required to support a managed cluster will vary based on the number of member servers and the redundancy configuration that has been selected. In some clustering configurations, the number of RJ45 cables that are needed is double the number of members servers that are in the stack. Some configurations may utilize more cables. For instance, in the illustrated prior art configuration, each chassis 310a-j includes two different servers (e.g., sleds 110a-n, 115a-n), each of which includes both a downstream wired connection and an upstream wired connection with neighboring servers in the stack.

Correctly configuring such wired topologies can be challenging for datacenter administrators as there are numerous opportunities to incorrectly couple any of these network cables. Moreover, any minor error in the stacking topology may result in various types of misconfigurations including network loops and outright omission of servers from the cluster, as well as causing a variety configuration issues that may be difficult to diagnose.

One of the limitations of wired clustering 300 is the requirement for a first server 310a and last server 310j in the stack to be coupled through wired connections 315a-b directly to network switch 305, which provides IP addresses or other network information needed to establish a connection with remote management tools. This creates the requirement for the cluster members 310a-j to remain in close proximity to each other, and thus also to the network switch 305 providing access to the management network.

Another limitation in such existing systems is the need for servers to be placed in immediately proximity to one another in order to accommodate the use of relatively short lengths of cable. In scenarios where there is a disconnect between stacked servers, such as due to a loose connection at either end of any of the cables, an administrator must find and correct such errors, which can be challenging in a datacenter with large numbers of nearly identical racks of computing systems. As datacenters are being employed more at edge locations, such locations may be difficult for an administrator to reach in a timely manner. Moreover, at such edge locations, administrators face further complications in diagnosing and repairing subtle errors in complex cabling topologies that are required by existing managed clusters.

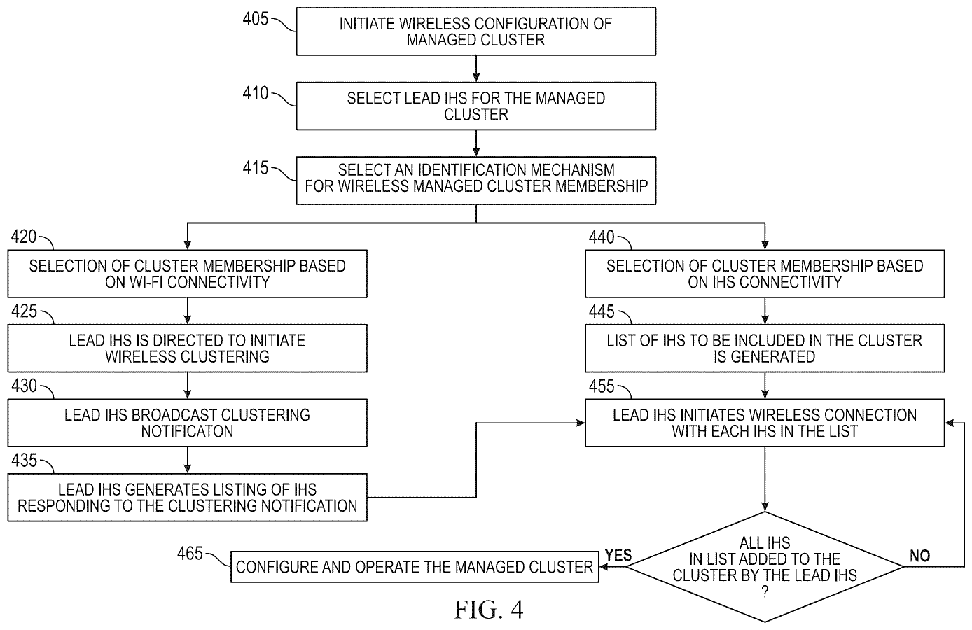

FIG. 4 is a flowchart illustrating certain steps of methods, according to some embodiments, for wireless configuration of rack-mounted IHSs as members of a managed cluster. Embodiments may begin, at 405, with a human and/or automated management tool initiating wireless configuration of a managed cluster from a set of IHSs that are configured as servers IHSs 200, such as described with regard to FIG. 2, and that may be installed within a rack-mounted chassis 100, such as described with regard to FIG. 1. Such managed cluster configurations may be initiated when the server IHSs are received at the datacenter and being installed for the first time, or may be initiated at a later time, such as when the servers are being re-imaged and/or re-purposed.

Configuration of the managed cluster continues, at 410, with the designation of a lead server IHS 100 that is to be responsible for managing administrative operations for the member servers of the managed cluster. The lead server may be the primary interface for monitoring, managing, and configuring all members of the managed cluster, including server IHSs 200, storage sleds 115a-n, and networking equipment. The lead server may be configured to collect and aggregate real-time hardware health data, such as CPU temperature, fan speeds, power supply status, and disk health, from all IHSs that are members of the managed cluster, such as through operations of the remote access controller 255 installed in each of the member server IHSs of the cluster

The lead server may monitor hardware operations throughout the managed cluster and may automatically trigger alerts when issues are detected, providing early warnings that enable administrators to take preventive action before a failure occurs, thus minimizing downtime and ensuring continuous operation of the data center. Additionally, the lead server facilitates automated hardware management tasks for each of the member IHSs, such as firmware updates, hardware configuration, and troubleshooting. Through remote management tools 101, the lead server enables administrators to deploy firmware and other software updates across multiple servers simultaneously. The lead server may also automate provisioning, enabling new servers to be added to the managed cluster with minimal manual intervention. When hardware issues arises in any of the members of the managed cluster, the lead server may be used to initiate diagnostics, hardware resets, or power cycling in any or all of the members. The lead server may also schedule maintenance tasks, such as hardware diagnostics or firmware patches.

Once the lead server for the managed cluster has been identified, such as through a service tag, wireless network address, or other unique identifier of the lead server IHS, at 415, a mechanism is selected for identifying the IHSs 200 that are to be included as members of the managed cluster. In some instances, a listing of the servers to be included in the managed cluster may be readily available, such as when provisioning a set of newly received group of IHSs that are being deployed as servers, or such as provisioning of set of re-imaged servers as a managed cluster for a specific customer or for a specific computing workload (e.g., in support of specific cloud).

In such instances, at 440, the option is selected for establishing membership in the managed cluster based on a listing of servers that is provided to the lead server, such as through human and/or automated remote management tools 101. At 445, a listing of the servers to be added to the managed cluster is generated for use by the lead server in wireless configuration of the managed cluster. In some embodiments, the listing of servers may specify a wireless network address of each server IHS 200 to be included as a member of the managed cluster by the lead server, such as the wireless network address of the remote access controller 255 of the IHS 200 to be included.

In some embodiments, the listing of servers may specify additional information for use by the lead server in identifying and authenticating each IHS that is to be a member of the managed cluster. In some embodiments, the listing may specify a digital signature by which to identify a factory provisioned inventory certificate of each IHS 200 that is to be included as a member of the managed cluster. In such embodiments, the lead server may utilize the inventory certificate to authenticate the hardware of a member IHS as being factory-installed prior to including the member into the managed cluster.

In other scenarios, at 420, the option is selected for establishing membership in the managed cluster based on Wi-Fi connectivity with the lead server. In such instances, the IHSs that may be added as members to the managed cluster by the lead server are those that have been configured to respond to wireless clustering broadcasts issued by the lead server. At 425, the lead server is directed to initiate wireless clustering of IHSs that are within wireless communication range and that provide valid responses to wireless clustering handshake communications by the lead server.

In some embodiments, the lead server may be provided within a name or other identifier for the wireless network to be used by the managed cluster and/or with Multicast DNS (mDNS) information for use in broadcasting wireless clustering communications, such as providing a specific multicast address to be used in the broadcast for a specific managed cluster. In some embodiments, the lead server may be provided an SSID local wireless network to used by the lead server in wireless management of the member servers that are part of the managed cluster.

In some embodiments, the wireless clustering communications are transmitted by a wireless network adapter 255c of the remote access controller 255 of the lead server IHS 200. This wireless interface of the remote access controller may be configuring to operate in the local datacenter network environment. Once the remote access controller 255 of the lead server is directed to initiate wireless clustering, at 430, the remote access controller may initiate transmission of a wireless mDNS signal to broadcast its identity and the identity of the managed cluster. In some embodiments, the mDNS broadcast may also include the name of the SSID of the wireless network to be used by the managed cluster. In some embodiments, the mDNS query may sent over UDP to the local datacenter network, using a multicast address that is selected as being on the same wireless network segment that is being monitored for broadcasts by remote access controllers installed in IHSs according to embodiments in the datacenter.

Upon the mDNS broadcast being received by other remote access controllers in the datacenter, the wireless clustering information provided in the broadcast is evaluated in order to determine wither the receiving remote access controller will respond. In some instances, a remote access controller of a server within wireless range of the lead server may be configured not to respond to the mDNS broadcast, such as when the receiving server is already a member of a different managed cluster with a different lead server. In some scenarios, a remote access controller may be configured to join a managed cluster, but it is a different managed cluster than the one that is being broadcast by the lead server.

In some embodiments, the remote access controller of each IHS 200 that is being designated as a member of a computing cluster may be configured to respond to wireless clustering mDNS broadcasts that are transmitted at a specific multicast address, or with a range of addresses. In some embodiments, the remote access controller of each IHS 200 that is being designated as a member of a computing cluster may be configured to respond to wireless clustering mDNS broadcasts only if broadcasts specify use of particular SSID for the wireless management network that will be used for management of the cluster by the lead server. In scenarios where a remote access controller responds to the broadcast with an mDNS reply transmission, the reply may include information identifying the responding remote access controller and/or the IHS that is now requesting membership in the managed cluster.

With each mDNS reply received from neighboring servers, the remote access controller of the lead server processes the incoming replies and parses the information in the mDNS replies in order to identify valid responses from known and trusted servers. After a duration for replies has expired, at 435, the lead server generates a list of the replying servers that identifies the replying servers by a device names, IP addresses, and any additional attributes included in the mDNS replies, such as confirmation that the replying server has detected the wireless cluster network of the SSID specified in the mDNS broadcast.

As indicated in FIG. 3, both in scenarios where the listing of member servers to be added to the managed cluster is generated by the lead server through wireless broadcasts, or whether the listing of member servers is provided to the lead server, at 455, the lead server begins iterating through this list of servers that are to be added to the managed cluster. The lead server may evaluate the responses to confirm each responding server is an authorized member of the managed cluster. In scenarios where the listing of member servers has been provided to the lead server, this listing may also specify requirements for the lead server to utilized in authenticating a response. For instance, the lead server may issue challenges to establish proof of possession by the remote access controller of a replying server of a cryptographic key used to sign and validate the digital inventory certificate of the replying server, thus confirming the replying remote access controller as trusted and confirming the replying server is operating using factory-installed hardware.

In scenarios where the list of servers to be added to the managed cluster is generated by the lead server through wireless clustering broadcasts, the lead server may initiate handshake procedures with each replying server in order to authenticate the replying server, or at least the remote access controller of the replying server. In some embodiments, this handshake procedure may similarly confirm the replying server's possession of the key used to sign its factory-provisioned inventory certificate. If a replying server is successfully authenticated, the lead server may enroll the replying server into the managed cluster, assigning each new member roles and configurations as appropriate, including unique identifiers and network configurations for communication within the managed cluster. Once, at 460, the lead IHS has iterated through the list of servers to be added, the enrolled member servers are now considered part of a unified management system, allowing them all to be managed, at 465, through management operations of the lead server.

Once each replying server is enrolled in the managed cluster, the lead sever may further configure their use of the sideband wireless management network being used by the lead server. The lead server may transmit wireless configuration parameters to each member server, such as credentials for connecting to the wireless network identified by the SSID of the managed cluster, security protocols (e.g., WPA2 or WPA3), and any required authentication credentials. Upon receiving this information, the member servers update their network settings to connect to the specified wireless management network. Each member server initiates a wireless connection with the lead server via the sideband management network and is authenticating to establish a secure connection.

In some embodiments, the lead server may enroll certain of the member servers in one or more managed sub-clusters of the managed cluster. For instance, handshake procedures may be utilized in determining that a subset of the member servers include a distinct hardware configuration that does not prevent joint administration of these member servers along with other members of the managed cluster, but this subset of servers provides a need for some additional administration. For instance, a portion of the member servers in a managed cluster may include a specialized FPGA 220. In such instances, embodiments may categorize this portion of the member servers according to a sub-cluster of the main managed cluster. All administration of the main managed cluster is applicable to the member servers of this sub-cluster, but the sub-cluster may be additionally administered by the lead server, such as in facilitating updates and/or reprogramming of FPGAs 220 installed in the member servers of the sub-cluster.

In some embodiments, the lead server may maintain the integrity and accuracy of the member servers in the managed cluster by periodically broadcasting mDNS queries and revalidate the responses from each of the member servers. This ensures that the membership of the managed cluster remains current and reflects any changes in the server environment. If a member server's response is no longer received, or if an inconsistency is detected in the data, the lead server may alert administrators regarding the missing or malfunctioning member server.

As opposed to the static cluster membership of existing wired managed cluster, embodiments may support dynamic membership in a managed cluster. In existing wired managed clusters, membership in a managed cluster cannot be readily reconfigured to accommodate membership in a different managed cluster. In embodiments, any IHS 200 according to embodiments that is a member of an initial managed cluster may be configured to switch to management by a second managed cluster, such as due to re-assignment of the IHS for use in implementing a cloud system for a different datacenter customer. In some embodiments, an IHS 200 may be directed to switch to management by a specialized management cluster, such as to accommodate specialized reprogramming of FPGA operations 220 in the IHS, by reassigning the IHS to use of the wireless network in use by that specialized management cluster.

In implementing managed cluster re-assignment, the remote access controller 255 of the IHS that is being transferred to the second managed cluster may be directed to monitor for wireless clustering broadcasts by the lead server of the second managed cluster to which the IHS is being transferred, and further directed to initiate procedures for switching to management by the second managed cluster. The remote access controller 255 may identify these broadcasts based on the subnet address that is utilized and based on the SSID or other identifier in use by the wireless network of the second managed cluster. In this manner, different SSIDs may be used for different managed clusters that are operating within the datacenter, with the lead server of each managed cluster responsible for managing the wireless network, that may be identified by an SSID or any other identifier suitable for identifying and discerning the different wireless management networks that are in operation within the datacenter.

Switching IHSs between different managed clusters may then be provided in embodiments through re-assigning the IHS to use of a different wireless network. Once the remote access controller 255 has completed the necessary wireless handshake procedures that are required for membership in the second managed cluster, the lead server of the initial managed cluster and the lead server of the second managed cluster may exchange information in order to support the transfer of administration of the IHS through the lead server of the second managed cluster. In some instances, such transfers in cluster membership may be for a limited purposes, such as for the described reprogramming of FPGAs 220, after which the IHS may be returned to management in the original cluster by directing the IHS to listen for broadcasts from the lead server of the original cluster, thus supporting dynamic cluster memberships within rack-mounted servers.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method for wireless configuration of a managed cluster comprising a plurality of IHSs (Information Handling Systems), the method comprising:
selecting a lead IHS for the managed cluster;
directing the lead IHS to utilize a specified wireless network in administration of IHSs that are members of the managed cluster;
generating a list of IHSs to be included as members of the managed cluster;
initiating, by the lead IHS, a wireless connection with each of the plurality of IHSs in the list of IHSs to be included as members of the managed cluster; and
using, by the lead IHS, the wireless connection with each of the plurality of IHSs to configure each respective IHS as a member of the managed cluster.

2. The method of claim 1, further comprising directing the lead IHS to generate the list of IHSs to be included in the managed cluster based on wireless broadcast notifications.

3. The method of claim 2, wherein the lead IHS is provided a subnet address for use in transmitting the wireless broadcast notifications.

4. The method of claim 3, wherein each of the plurality of IHSs to be included as members of the managed cluster is configured to monitor for broadcasts on the subnet address in order to initiate wireless administration by the lead IHS as a member of the managed cluster.

5. The method of claim 2, wherein each of the plurality of IHSs to be included as members of the managed cluster is further configured to monitor for broadcast notifications by a wireless management network identified by a specific SSID.

6. The method of claim 2, wherein the lead IHS broadcasts the wireless clustering notifications on one or more wireless networks of a datacenter.

7. The method of claim 6, wherein the list of IHSs to be included as members of the managed cluster comprises IHSs that respond to the wireless clustering notification broadcast by the lead IHS.

8. The method of claim 1, wherein the generated list of IHSs to be included as members of the managed cluster comprises credentials for use in authenticating each of the respective IHSs in the list.

9. The method of claim 5, wherein the lead IHS utilizes the credentials to establish a secure wireless connection with each IHS in the list.

10. The method of claim 1, further comprising identifying, by the lead IHS, a subset of the IHSs to be included as members of the managed cluster that each include a specific hardware system not present in other IHSs to be included as members of the managed cluster and generating a managed sub-cluster that includes the subset of the IHSs that include the specific hardware system.

11. The method of claim 10, wherein the managed sub-cluster is utilized by the lead IHS administration of the specific hardware system utilized by the subset of IHSs.

12. The method of claim 1, further comprising reassigning a first IHS from membership in the managed cluster administered by the lead IHS to membership in a different managed cluster that is administered by a different lead IHS.

13. The method of claim 12, wherein the reassignment of the first IHS comprises directing the first IHS to switch to use of a wireless network in use by the different IHS in management of the different managed cluster.

14. An IHS (Information Handling System) comprising:
one or more processors;
one or more memory devices coupled to the processors, the memory devices storing computer-readable instructions that, upon execution by the processors, cause the IHS to:
receive notification the IHS has been selected as lead IHS for the managed cluster;
receive notification of a specified wireless network for use in administration of IHSs that are members of the managed cluster;
generate a list of IHSs to be included as members of the managed cluster;
initiate a wireless connection with each of the plurality of IHSs in the list of IHSs to be included as members of the managed cluster; and
use the wireless connection with each of the plurality of IHSs to configure each respective IHS as a member of the managed cluster.

15. The IHS of claim 14, wherein the IHS generates the list of IHSs to be included in the managed cluster based on wireless broadcast notifications.

16. The IHS of claim 15, wherein the IHS broadcasts the wireless clustering notifications on one or more wireless networks of a datacenter.

17. The IHS of claim 16, wherein the list of IHSs to be included as members of the managed cluster comprises IHSs that respond to the wireless clustering notification broadcast by the IHS.

18. A computer-readable storage device having instructions stored thereon for management of a cluster by an IHS (Information Handling System), wherein execution of the instructions by one or more processors of the IHS causes the one or more processors to:
receive notification the IHS has been selected as lead IHS for the managed cluster;
receive notification of a specified wireless network for use in administration of IHSs that are members of the managed cluster;
generate a list of IHSs to be included as members of the managed cluster;
initiate a wireless connection with each of the plurality of IHSs in the list of IHSs to be included as members of the managed cluster; and
use the wireless connection with each of the plurality of IHSs to configure each respective IHS as a member of the managed cluster.

19. The computer-readable storage device of claim 18, wherein the IHS generates the list of IHSs to be included in the managed cluster based on wireless broadcast notifications on one or more networks of a datacenter.

20. The computer-readable storage device of claim 19, wherein the list of IHSs to be included as members of the managed cluster comprises IHSs that respond to the wireless clustering notification broadcast by the IHS.
